(19) United States
(12) Patent Application Publication
(10) Pub. No.: US 2012/0080374 A1
(43) Pub. Date: Apr. 5, 2012

(54) OZONE AND ANAEROBIC BIOLOGICAL PRETREATMENT FOR A DESALINATION PROCESS

(75) Inventors: Andy Komor, Irvine, CA (US); Keisuke Ikehata, Fountain Valley, CA (US)

(73) Assignee: Pacific Advanced Civil Engineering, Inc.

(21) Appl. No.: 12/897,576

(22) Filed: Oct. 4, 2010

(51) Int. Cl. C02F 9/14; C02F 1/58; C02F 3/34; C02F 1/78; C02F 3/28

(52) U.S. Cl. 210/603; 210/631

(57) ABSTRACT

In one embodiment, a method of treating a source water containing at least one toxin is provided, the method comprising: (i) exposing a source water to a gas comprising ozone under a condition that promotes an interaction between the toxin and the ozone; and then (ii) subjecting the treated source water to a biological treatment.

### FIELD OF THE INVENTION

The invention is related to water purification and reclamation, in which contaminated water is treated by a series of unit treatment processes, such as physical, chemical and biological treatment processes.

All of the references cited in this Specification are incorporated herein by reference in their entirety.

### BACKGROUND

Due to serious water shortage problems, water producers (e.g., utilities) and water users are seeking new water resources that have not been explored previously. These water resources include treated sewage effluent, brackish groundwater, treated industrial and agricultural wastewater, and seawater. Typically, water from these water resources contains high salinity and other dissolved constituents that need to be removed or degraded. Although most of the dissolved water constituents may be removed by contemporary desalination technologies, such as membrane processes, a small volume of highly concentrated brine streams that contain virtually all the constituents in the source water is generated as a waste of such desalination processes. The waste brine needs to be disposed of properly in order to minimize the impact on the public and environmental health.

Oxidized selenium species (e.g., oxyanion) is one toxin that has been identified as one of the major health concerns in agricultural drainage waters. Drainage water may contain up to 330 μg Se/L. A four- to six-fold increase in selenium concentration can be found in desalination brine. Selenium can bioaccumulate and kill aquatic organisms and birds.

A number of patents (e.g., Oremland, U.S. Pat. No. 5,009,786) have disclosed chemical and biological methods to remove toxic, aqueous selenium species from contaminated water. For example, it is known that anaerobic biological treatment can convert aqueous selenate (SeO₄²⁻) into selenides (e.g., HSe⁻, organic selenium, and metal selenides) and elemental selenium that may be precipitated or incorporated into cell biomass and removed from water. However, none has discussed the use of anaerobic biological processes as a pretreatment of selenium-containing water desalination. It is known that selenium and other metal and nonmetal oxyanions are present in different oxidation states in water. In order for a pretreatment system to work properly, it is important to oxidize or reduce these species prior to the pretreatment.

Thus, a need exists to provide a pretreatment method and/or system to remove undesirable toxic metal- and/or nonmetal-containing species and/or harmful organic materials prior to subjecting a source water to a desalination process.

### SUMMARY

An object of the present invention is to remove the presence of toxin and/or dissolved carbon-containing organic materials from a contaminated source water using a gas treatment that is followed by a biological treatment prior to the desalination process. The removal of such contaminants before the desalination process allows the reject stream from the desalination process to be free of toxic metal- and nonmetal-containing species and organics; which in turn reduces the harmful impact upon the environment and public health during storage and disposal.

In one embodiment, a method of treating a source water containing at least one toxin is provided, the method comprising: (i) exposing a source water to a gas comprising ozone under a condition that promotes an interaction between the toxin and the ozone; and then (ii) subjecting the source water to a biological treatment.

Provided herein in another embodiment is a desalination plant, in which, prior to desalination, a source water undergoes a gas treatment and a biological treatment.

An alternative embodiment provides a method of desalination, the method comprising (i) exposing a source water containing at least one toxin to a gas comprising ozone under a condition that promotes an interaction between the toxin and the ozone; then (ii) subjecting the source water to a biological treatment; and then (iii) subjecting the treated source water to a desalination process.

In another embodiment, a method of treating an oxidized source water containing at least one toxin is provided, the method comprising: subjecting the oxidized source water to an anaerobic biological treatment, whereby the toxin is removed from the source water after the treatment.

### BRIEF DESCRIPTION OF THE DRAWINGS

FIG. 1 illustrates a set up of the ozone contactor and bioreactors in one embodiment.

FIG. 2 provides the experimental data of the removal profile of selenium by a batch bioreactor in one embodiment.

### DETAILED DESCRIPTION

The pretreatment process and system described herein utilize a combination of a gas and biological treatment as a pretreatment method of brackish source water prior to desalination to minimize foulants and flowing toxic species that would otherwise get into the concentrated brine stream. In one embodiment, the gas treatment utilizes a gas comprising ozone. In another embodiment, the biological treatment utilizes an anaerobic treatment. Prior to the anaerobic treatment, ozone can be used to break down bio-recalcitrant organic compounds, and the anaerobic treatment process can be used to remove toxins, such as selenium and/or organics. The latter can be carried out through multiple gravity fed tanks in series and/or recirculation streams. Effluent of the anaerobic bioreactors can be treated through contemporary desalination processes, such as ion exchange, membrane filtration, and distillation.

In one embodiment, a combination of ozone and anaerobic biological treatment is used to pretreat a source water prior to the desalination process. Water contaminated with a toxin, such as metal- or nonmetal-containing species, including selenium, and organics can be impounded in a tank or reservoir. If needed, appropriate pretreatment, such as grit and suspended solids removal, equalization, and/or neutralization, can be further used prior to the ozone and anaerobic biological treatment.

### Ozone Treatment

The source water that undergoes a desalination process often contains species that are undesirable for human consumption and/or toxic to wildlife. The source water can comprise any brackish water, including brackish groundwater, agricultural drain water, treated sewage effluent, treated industrial or agricultural wastewater, seawater, or combinations thereof. The harmful toxin present in the source water can be an inorganic species, an organic species, or a combination thereof. For example, the inorganic species can be a metal- or nonmetal-containing species. The term “metal- or nonmetal-containing species” herein refers to an entity that comprises an elemental metal or nonmetal in its chemical formula; the entity can be in an elemental form, such as a solid metal or nonmetal, gaseous metal or nonmetal, metal or nonmetal compound, metal alloy, or combinations thereof, or in an ionic form, such as in a cation form or an anion form. “Element” herein refers to the element in a Periodic Table. The organic material can be a natural or a synthetic organic material, such as an organic compound, such as a carbon-containing organic material or compound. For example, the organic material can be pesticides, antibiotics, and humic substances in water and wastewater, or combinations thereof.

The gas used in the gas treatment can comprise ozone; in one embodiment, the gas consists essentially of ozone. Ozone can be used to oxidize, at least partially, synthetic and natural organic compounds that are either toxic or highly resistant to biodegradation. Oxidized organic compounds are generally less toxic and easier to biodegrade. By combining an ozone treatment with a biological treatment, organic matters in contaminated water may be better utilized by microorganisms and thus reduced effectively. If not removed properly prior to the desalination process, organics may foul the desalination process, such as the reverse osmosis membrane used therein.

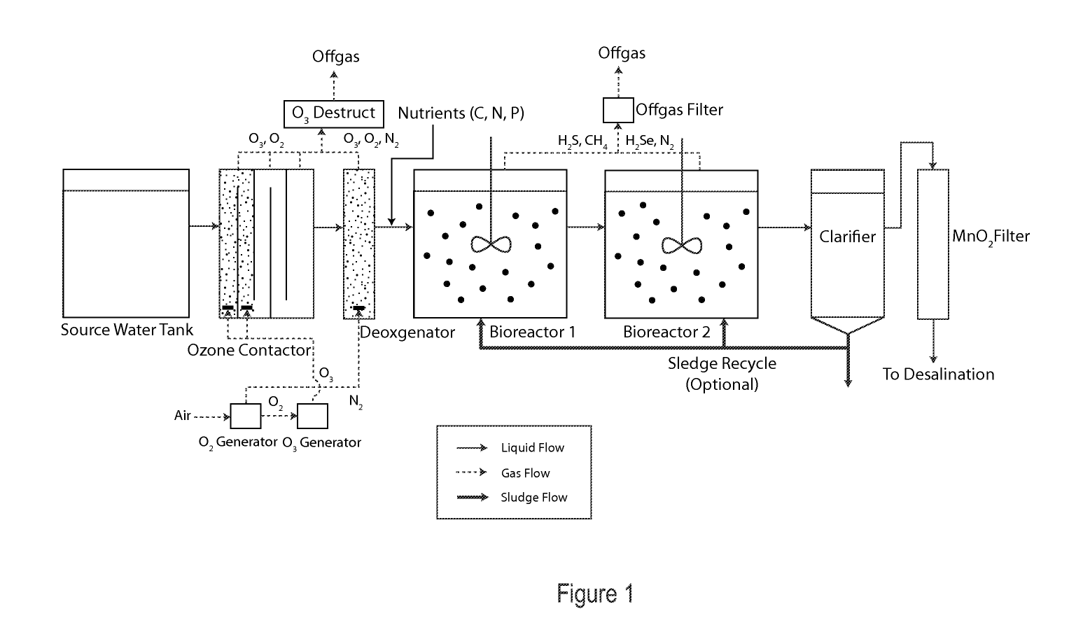

Ozone gas (O₃) can be either injected into or bubbled through the water in an enclosed environment, such as an enclosed ozone contact tank, where separated compartments allow enough contact time for dissolved organics to be oxidized. Ozone gas can be obtained by any suitable methods. For example, ozone gas can be generated by an ozone generator on site using purified oxygen (O₂), which is generated by an oxygen generator. Alternatively, ozone gas can be obtained from another location, such as from a commercial source. Bubble-diffusers are shown in FIG. 1. The ozone gas is provided into the source water such that the source water is exposed to the ozone under a condition that promotes an interaction between the species in the source water, which species is to be subsequently removed, and the ozone gas. The interaction herein can refer to, for example, oxidation. In addition to oxidizing organic matter as described above, ozone can oxidize other toxins. For example, ozone can be used to oxidize selenium-containing species having lower oxidation states, including HSe⁻, SeO₃²⁻, and/or organic selenium, to SeO₄²⁻. SeO₄²⁻ can later be processed, such as reduced by a microorganism, such as a selenate respiring bacterium or archaeon, in subsequent bioreactors. In addition, ozone can be used to oxidize other inorganic species, such as arsenite, iron, manganese, mercury, chromium, cadmium, lead, antimony, sulfide, ammonia, or combinations thereof, to their respective higher oxidation states. In one embodiment, oxidized iron and manganese can precipitate out, and in some embodiments they may further be removed by sedimentation or filtration prior to the anaerobic treatment.

In one embodiment, ozone can first oxidize dissolved organics, such as pesticides and humic substances, and render them into more easily biodegradable smaller compounds. Ozone also can oxidize at least one toxin, including a metal- or nonmetal-containing species, such as a selenium-containing species having a lower oxidation state, such as selenite, selenide, or a combination thereof. The oxidized selenium-containing species, SeO₄²⁻, can be subsequently removed by a biological process treatment, such as an anaerobic biological process. This step can be very important because: (1) there are fewer selenite-respiring microbial species than selenate-respiring species in the anaerobic microbial populations; and (2) selenite may constitute a majority of dissolved selenium species in the source water to be treated. Other oxidized metal- and/or nonmetal-containing toxins, such as nitrate, arsenic, mercury, chromium, cadmium, lead, and antimony, may be removed by a similar biological reduction. In addition, perchlorate may be reduced to chloride by the anaerobic treatment. The biological process can be carried out in one anaerobic bioreactor or a series of anaerobic bioreactors. See FIG. 1. The biological process is described further below.

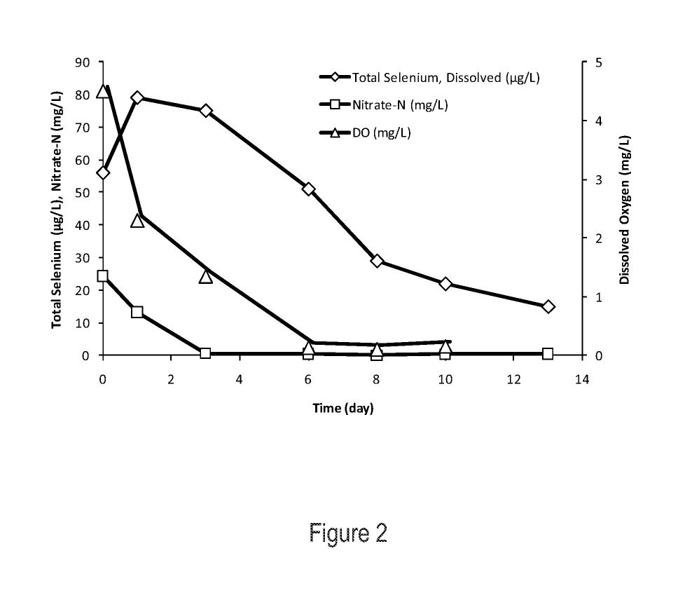

The ozonated water can be subjected to a deoxygenator, in which nitrogen gas (N₂) is bubbled into the water column to strip off dissolved oxygen and any residual O₃ from the water, because dissolved oxygen can inhibit, or slow down, the downstream anaerobic process. The experimental data (FIG. 2) show that selenium removal in one embodiment can occur when dissolved oxygen, as well as nitrate, dropped below about 3 mg/L, such as below about 2 mg/L, such as below about 1 mg/L. For health and safety reasons, off gas from the ozone contactor and deoxygenator, about 3 mg/L, such as about 2 mg/L, such as about 1 mg/L, is preferably collected, and any residual ozone is preferably destroyed and/or recycled before releasing it to the atmosphere.

### Anaerobic Biological Treatment

The deoxygenated water can be treated by a biological process. In one embodiment, the biological process is carried out in a series of anaerobic bioreactors. The oxidized toxin, such as oxidized metal- and nonmetal-containing species, can be removed during the biological process. In one embodiment, the oxidized organic material can also act as a carbon source for the biological treatment.

For example, as seen in FIG. 1, two completely mixed, attached growth bioreactors can be used in one embodiment. In the first bioreactor, nitrate (NO₃⁻) is reduced to nitrogen gas. The effluent of the first bioreactor can be fed into the second bioreactor, wherein the metal- and nonmetal-oxyanions therein can be reduced biologically. In one embodiment, SeO₄²⁻ can be reduced to either elemental selenium)(Se⁰) or HSe⁻ by a bacterium, such as a selenate respiring bacterium or archaeon. Microorganisms used for the anaerobic bioreactors can be obtained from a variety of sources. One example is an anaerobic digester in a municipal wastewater treatment plant. Enrichment of cultures of selenate respiring microorganisms can be performed prior to their use in the bioreactors.

In addition to nitrate and biodegradable compound, sulfate can also be reduced during the treatment. Sulfate reduction may also occur simultaneously in the second bioreactor. In one embodiment, the sulfate reduction can be monitored to avoid having excessive sulfate reduction, which can impede selenate reduction. Other anaerobic reactions that may occur in the second bioreactor include formation of fatty acids, methane, and/or hydrogen gas.

Ozonated organics can be utilized as a carbon source for the anaerobic process. Additionally, a carbon source, such as acetate, as well as nitrogen, phosphorous, and other trace elements that can serve as electron donors, can be fed into the bioreactors. Furthermore, iron (II) can be added as another electron donor. Dissolved organic carbon derived from the source water may also be utilized as a carbon source and electron donor because it becomes more easily biodegradable after ozone treatment. The electron donor can lower the carbon addition requirement. This is another advantage of using ozone.

The effluent of the second bioreactor can be fed into a solid-liquid separation unit, such as a clarifier and/or a dissolved air flotation unit. In the solid-liquid separation unit, the toxin that has undergone the prior treatments is to be removed and separated from the water. The separation can be carried out by precipitation, filtration, or a combination thereof. For example, in one embodiment, elemental selenium and/or metal selenide can precipitate in the bioreactors or be removed by a solid-liquid separation unit downstream of the bioreactors. As described previously, oxidized iron and/or manganese can be precipitated out and removed before the anaerobic treatment.

In one embodiment, excess biomass, elemental selenium, and metal selenides precipitates can be collected as a sludge, which may be partially recycled back to the bioreactors to increase the solid retention time. The effluent from the solid-liquid separation unit can be filtered through a filter medium, such as a manganese dioxide (MnO₂) medium, to remove residual suspended solids, as well as dissolved sulfide and selenide. In one embodiment, the MnO₂ medium can oxidize sulfide and selenide to elemental sulfur and selenium, respectively, at neutral to basic pH. For example, in one embodiment, the pH ranges from 7 to 9. Thus, it can be important to monitor the effluent pH. Such an additional oxidation step can substantially minimize hydrogen sulfide odor and residual selenide from the water. Finally, the water can then be sent to a desalination process as shown in FIG. 1. The desalination process can be any suitable desalination process, such as one comprising reverse osmosis, nanofiltration, electrodialysis, electrodialysis reversal, distillation, ion exchange, or combinations thereof.

### Applications

The presently described processes can also be used to retrofit a pre-existing desalination plant. For example, the ozone and anaerobic treatment units can be installed into a pre-existing desalination plant. In one embodiment, therefore, the desalination process would comprise subjecting the source water first to the ozone gas and biological treatment as described previously prior to the desalination process. The presently described system can also be in the form of a desalination plant that is equipped to perform the processes described previously. For example, it can be a desalination plant, in which the source water undergoes a gas treatment and a biological treatment prior to the desalination process. As described previously, the ozone treatment need not be at the same location as the biological treatment and the desalination plant. For example, the ozone-treated (or oxidized) source water can be shipped from another location to the plant to undergo the anaerobic biological treatment prior to the desalination process. Thus, in one embodiment, the “toxin” in the oxidized source water can be already in an oxidized form.

### Non-Limiting Working Example

The experimental results of using the aforedescribed processes with a batch anaerobic bioreactor to remove toxin from water in one embodiment are illustrated in FIG. 2, and are described as follows.

The experiment was conducted at temperature=24 to 26° C. and pH=7.5 to 7.8. The source of anaerobic sludge used was anaerobic digester sludge from a municipal wastewater treatment plant. On day 0, 420 mg/L diammonium phosphate was added to supplement phosphorus.

FIG. 2 shows that selenium removal occurred when dissolved oxygen, as well as nitrate, dropped below 1 mg/L. FIG. 2 clearly demonstrates that the toxins in the water, including selenium and nitrate, were effectively removed by the method and bioreactor described above.

The above detailed description illustrates specific embodiments of the invention, but is not meant to limit the scope of the invention. Unless otherwise specified, the words “a” or “an” as used herein mean “one or more.” The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

What is claimed:

1. A method of treating a source water containing at least one toxin, comprising:
(i) exposing a source water to a gas comprising ozone under a condition that promotes an interaction between the toxin and the ozone; and then
(ii) subjecting the source water to a biological treatment.

2. The method of claim 1, further comprising subjecting the treated water to a desalination process after step (ii).

3. The method of claim 1, wherein the source water comprises brackish groundwater, agricultural drain water, treated sewage effluent, treated industrial or agricultural wastewater, seawater, or combinations thereof.

4. The method of claim 1, wherein the source water comprises an organic material.

5. The method of claim 1, wherein step (i) further comprises oxidizing an organic material present in the source water.

6. The method of claim 5, wherein the oxidized organic material acts as a carbon source for the biological treatment in step (ii).

7. The method of claim 1, wherein the interaction in step (i) is an oxidation of the at least one toxin by the gas.

8. The method of claim 1, wherein step (ii) further comprises removing the at least one toxin by the biological treatment.

9. The method of claim 1, wherein the toxin comprises a metal containing species, a nonmetal containing species, or a combination thereof.

10. The method of claim 1, wherein the toxin comprises an organic species, an inorganic species, or both.

11. The method of claim 1, wherein the toxin comprises oxyanion.

12. The method of claim 1, wherein the toxin comprises arsenite, iron, manganese, mercury, chromium, cadmium, lead, antimony, sulfide, ammonia, or combinations thereof.

13. The method of claim 1, wherein the toxin comprises HSe⁻, SeO₃²⁻, organic selenium, or combinations thereof.

14. The method of claim 1, wherein the toxin after step (i) comprises metal selenium, selenate, or a combination thereof.

15. The method of claim 1, wherein step (ii) further comprises reducing nitrate, sulfate, biodegradable organic compounds, or combinations thereof present in the source water.

16. The method of claim 1, wherein step (ii) is carried out in at least one anaerobic bioreactor.

17. The method of claim 1, wherein the biological treatment is an anaerobic biological treatment.

18. The method of claim 1, further comprising removing and collecting the gas.

19. The method of claim 1, further comprising after step (ii) separating the oxidized toxin from the treated water.

20. The method of claim 19, wherein the separating is by precipitation, filtration, or a combination thereof.

21. The method of claim 19, further comprising after step (ii) oxidizing the separated and treated water.

22. The method of claim 19, further comprising after step (ii) removing, by oxidation from the separated and treated water, at least one of sulfide, selenite, iron, manganese, arsenic, chromium, lead, mercury, cadmium, perchlorate, and nitrate.

23. The method of claim 1, wherein the biological treatment is carried out with a microorganism.

24. The method of claim 1, wherein the biological treatment is carried out with a selenate respiring microorganism or archaeon.

25. A desalination plant, wherein prior to desalination a source water undergoes gas treatment and a biological treatment.

26. The desalination plant of claim 25, wherein the source water comprises at least one toxin.

27. The desalination plant of claim 25, wherein the source water comprises at least one organic material.

28. The desalination plant of claim 25, wherein the gas treatment involves exposing the source water to a gas comprising ozone.

29. The desalination plant of claim 25, wherein the biological treatment involves subjecting the source water to an anaerobic biological treatment.

30. A method of desalination, comprising
(i) exposing a source water containing at least one toxin to a gas comprising ozone under a condition that promotes an interaction between the toxin and the ozone; then
(ii) subjecting the source water to a biological treatment; and then
(iii) subjecting the source water to a desalination process.

31. The method of claim 30, wherein the toxin comprises selenium.

32. The method of claim 30, wherein the source water further comprises an organic material.

33. The method of claim 30, wherein the desalination process comprises reverse osmosis, nanofiltration, electrodialysis, electrodialysis reversal, distillation, ion exchange, or combinations thereof.

34. The method of claim 30, wherein biological treatment is carried out in a plurality of bioreactors.

35. A method of treating an oxidized source water containing at least one toxin, comprising: subjecting the oxidized source water to an anaerobic biological treatment, whereby the toxin is removed from the source water after the treatment.

36. The method of claim 35, wherein the source water is oxidized by an ozone treatment.

37. The method of claim 35, further comprising adding at least one electron donor into the source water prior to the anaerobic biological treatment.

38. The method of claim 35, wherein the toxin comprises selenium.

39. The method of claim 35, further comprising introducing a nitrogen gas into the oxidized source water to strip off dissolved oxygen and residual ozone from the water.

40. The method of claim 39, wherein the toxin is removed from the source water when the dissolved oxygen in the water becomes less than about 1 mg/L.
